(19) United States
(12) Patent Application Publication
(10) Pub. No.: US 2026/0289293 A1
(43) Pub. Date: Sep. 24, 2026

(54) Intentionally Incomplete Data Sensing for Correlated Data Reconstruction at the Edge

(71) Applicant: Dell Products L.P., Round Rock, TX (US)

(72) Inventors: Hoda Dehghan, Kanata (CA); Gwenael Poitau, Montreal (CA); Mohammad Alavirad, Kanata (CA); Ibrahim Abu Alhaol, Nepean, Ottawa (CA)

(21) Appl. No.: 19/085,952

(22) Filed: Mar. 20, 2025

(51) Int. Cl. G06N 3/08; G06N 3/042

(52) U.S. Cl. CPC G06N 3/08; G06N 3/042

(57) ABSTRACT

A system can train a first local model based on first locally-occurring data, wherein the first local model learns a first sensing matrix that samples the first locally-occurring data. The system can aggregate first information about the first sensing matrix with second information about second sensing matrices of second local models of second systems, wherein the second systems satisfy a data redundancy criterion with respect to the first system, to produce first aggregated information. The system can aggregate the first aggregated information with second aggregated information from second clusters different than a first cluster, to produce third aggregated information, wherein the first cluster comprises the first system and the second systems. The system can update the first local model based on the third aggregated information, to produce an updated first local model. The system can sense second locally-occurring data based on the updated first local model.

### BACKGROUND

Edge devices can work together to sense data.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can train a first local model based on first locally-occurring data, wherein the first local model learns a first sensing matrix that samples the first locally-occurring data to satisfy a sparseness criterion, and wherein learning the first sensing matrix omits sensing of all of the first locally-occurring data. The system can aggregate first information about the first sensing matrix with second information about second sensing matrices of second local models of second systems, wherein the second systems satisfy a data redundancy criterion with respect to the first system, to produce first aggregated information. The system can aggregate the first aggregated information with second aggregated information from second clusters different than a first cluster, to produce third aggregated information, wherein the first cluster comprises the first system and the second systems. The system can update the first local model based on the third aggregated information, to produce an updated first local model. The system can sense second locally-occurring data based on the updated first local model.

An example method can comprise training, by a first system comprising at least one processor, a first local model based on first locally-occurring data as input, wherein, based on the training, the first local model learns a first sensing matrix that samples the first locally-occurring data to satisfy a sparseness criterion, and wherein learning the first sensing matrix omits sensing all of the first locally-occurring data. The method can further comprise aggregating, by the first system, first information about the first sensing matrix with second information about second sensing matrices of second local models of second systems, wherein the second systems satisfy a data redundancy criterion with respect to the first system, to produce first aggregated information. The method can further comprise
aggregating, by the first system, the first aggregated information with second aggregated information from second clusters, to produce third aggregated information, wherein a first cluster comprises the first system and the second systems. The method can further comprise updating, by the first system, the first local model based on the third aggregated information, to produce an updated first local model. The method can further comprise sensing, by the first system, second locally-occurring data based on the updated first local model.

An example non-transitory computer-readable medium can comprise instructions that, in response to execution, cause a system comprising a processor to perform operations. These operations can comprise training a first model based on first data, wherein, as a result of the training, the first model learns a first sensing matrix that samples the first data to satisfy a sparseness criterion. These operations can further comprise aggregating first information about the first sensing matrix with second information about second sensing matrices of second systems, to produce first aggregated information. These operations can further comprise aggregating the first aggregated information with second aggregated information from second clusters, wherein a first cluster comprises the first system and the second systems, to produce third aggregated information. These operations can further comprise updating the first model based on the third aggregated information to create an updated first model. These operations can further comprise sensing second data based on the updated first model.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate intentionally incomplete data sensing for correlated data reconstruction at the edge, in accordance with an embodiment of this disclosure;

FIG. 2 illustrates an example of an objective function, and that can facilitate intentionally incomplete data sensing for correlated data reconstruction at the edge, in accordance with an embodiment of this disclosure;

FIG. 3 illustrates an example of an objective of each device of a group of devices, and that can facilitate intentionally incomplete data sensing for correlated data reconstruction at the edge, in accordance with an embodiment of this disclosure;

FIG. 4 illustrates an example of a complete optimization problem, and that can facilitate intentionally incomplete data sensing for correlated data reconstruction at the edge, in accordance with an embodiment of this disclosure;

FIG. 5 illustrates another example system architecture that can facilitate intentionally incomplete data sensing for correlated data reconstruction at the edge, in accordance with an embodiment of this disclosure;

FIG. 6 illustrates an example process flow that can facilitate intentionally incomplete data sensing for correlated data reconstruction at the edge, in accordance with an embodiment of this disclosure;

FIG. 7 illustrates another example process flow that can facilitate intentionally incomplete data sensing for correlated data reconstruction at the edge, in accordance with an embodiment of this disclosure;

FIG. 8 illustrates another example process flow that can facilitate intentionally incomplete data sensing for correlated data reconstruction at the edge, in accordance with an embodiment of this disclosure; and

FIG. 9 illustrates an example block diagram of a computer operable to execute an embodiment of this disclosure.

### DETAILED DESCRIPTION

### Overview

Correlated data sensing and computation at the edge can involve managing and processing data from multiple devices in decentralized locations, such as close to where the data is generated (e.g., at the “edge” of the network). This process can be used in scenarios where devices collaboratively sense and collect data, and where there is a need to understand the relationships or correlations between these data points across different devices.

In the context of correlated data sensing, an aim can be to capture the cross-correlation of multi-device data. This can comprise identifying and understanding the relationships and interactions between data collected from different sources. However, capturing this cross-correlation can be challenging due to the diverse nature of devices, the vast amount of data, and/or the potential for incomplete or noisy data.

An example of the present techniques can relate to image sensing for autonomous vehicles. Imagine a convoy of autonomous vehicles driving together, each equipped with multiple cameras capturing the surrounding environment. Rather than transmitting every camera frame in full, each vehicle can intentionally omit parts of its image data (e.g., skipping certain pixels or regions based on learned patterns) to conserve bandwidth and computational resources. At a nearby edge aggregator (such as an on-road unit or a lead vehicle), these incomplete image streams can be merged and reconstructed by exploiting correlations among the vehicles' fields of view-if one vehicle omits certain regions, it can be that a neighboring vehicle likely captured them, and so the combined input offers sufficient data to fill in gaps. This process uses learned sparsifying transforms (trained via federated learning) that adaptively determine which image regions are critical for safe navigation and which can be left out. By reconstructing a shared, near-complete “panoramic” scene from partial views, such a system can ensure robust situational awareness while drastically reducing total data transfer and preserving vehicle privacy.

Furthermore, the concept of a hierarchical model for edge data augmentation can address a need for, or desire to have, structured processing and enhancement of data at the edge. In some use-cases, data collected from edge devices can intentionally be incomplete to save bandwidth or due to privacy concerns. A hierarchical model can systematically manage this data, ensuring that despite the incompleteness, the data is still useful and can be augmented or enhanced to fill in the gaps. This model can work in layers, with each layer adding value or context to the data, thereby making it more comprehensive and useful for analysis.

The absence of such a hierarchical model for intentionally incomplete data sensing can pose a challenge. It can limit the ability to fully leverage the potential of edge computing and correlated compressive data sensing. Developing models and algorithms that can efficiently handle, process, and augment incomplete data while capturing the cross-correlations between data from multiple devices can be important. Such advancements can significantly enhance the efficiency and effectiveness of data-driven decision-making processes in various applications, from urban planning and environmental monitoring to healthcare and industrial automation.

The present techniques can be implemented to address these problems by implementing a distributed learning framework. This framework can employ a learnable sparsifying matrix, which can comprise the output of a generative model subject to specific objectives and constraints. A requirement of this approach can be the accurate reconstruction of an original signal using aggregated sensed data at the edge. Federated learning can be effective in this context as it can enable model training using decentralized data, which remains local to the devices. This approach can ensure privacy and minimize communication overhead.

The present techniques can differ from prior approaches in the use of generative AI (Gen AI or GenAI) to facilitate distributed sensing across multiple devices using a set of learned sparsifying matrices. Generative models can be utilized under the assumption of data sparsity, which can be a common condition in signal processing where signals are represented by a minimal number of non-zero coefficients. By applying these generative models, the present techniques can distribute the sensing task among multiple devices that all aim to achieve a common goal. This approach can both enhance the efficiency of data sensing in a distributed network of devices, and also leverage the inherent strengths of generative models to manage and interpret sparse data.

Another novel aspect of the present techniques can be the integration of GenAI for adaptive learning and real-time adjustments to the sensing process. This approach can optimize resource allocation, reducing latency and improving the efficiency of distributed sensing systems. Where the present examples involve optimizing something, or another superlative, it can be appreciated that there can be examples where that thing is satisfactorily improved, while not optimized.

Additionally, the present techniques can employ approaches in compressed sensing to reconstruct high-quality signals from incomplete data, enhancing the robustness and reliability of a system that implements the present techniques. This combination of GenAI and intentionally incomplete compressed sensing can offer capabilities that were unattainable in prior approaches.

That is the present techniques can be distinguished from prior approaches in multiple ways. For example, the present techniques can integrate generative models with distributed learning to handle cross-correlated and skewed data in a distributed sensing environment, marking a significant advancement in edge computing and IoT device management. Additionally, the use of GenAI can enable adaptive learning and real-time adjustments to optimize resource allocation, reduce latency, and enhance efficiency in distributed sensing systems.

Designing a hierarchical framework to learn sensing matrices that produce sparse outputs and sense intentionally incomplete data can involve a multi-faceted approach. A goal can be to leverage the data redundancy between adjacent devices, ensuring that the collective learning process is efficient and meets bandwidth constraints and privacy considerations. An example approach to achieving this is as follows.

For a distributed learning framework, multiple edge devices (e.g., Internet-of-Things (IoT) devices) can collaborate to learn a shared model while keeping the data localized. This can involve the following steps:
Local model training: Each device trains a local model on its data. In this context, the local model can focus on learning a sensing matrix that sparsely samples the local data.
Sparse sensing matrix: This can be designed to sample the input data sparsely, meaning it intentionally captures only a subset of the available data. This approach can be beneficial for reducing dimensionality of the data, saving bandwidth, and ensuring privacy. This concept can differ from compression, in which data is fully sensed and then reduced in size.
Intentional incomplete sensing: The sensing matrix can also be designed to sense data incompletely. This can be intentional, leveraging the fact that there is redundancy in the data collected by adjacent devices. It can be that the model does not need to capture all data points, as the missing information can be inferred or supplemented from other devices' data. Designing the sparsifying matrices for devices can be coordinated to span the entire space with minimal redundancy.

A hierarchical learning model can play a role in efficiently learning these sensing matrices. In an example, the hierarchical structure can be conceptualized as follows:
Local layer: At the lowest layer, individual devices can use local data to learn the initial sensing matrices. This layer can focus on capturing the most critical and representative features of the local data while ensuring sparsity and intentional data incompleteness.
Collaboration layer: Adjacent devices can form clusters to collaboratively share and aggregate their learning. In this layer, devices can exchange information about their sensing matrices and the sparse representations of their data. A goal can be to learn from the collective data without actually transmitting raw data, and minimizing bandwidth usage.
Global layer: At the highest layer, a global model can aggregate insights from all clusters. It can fine-tune the sensing matrices to ensure they are well-adapted to the collective data characteristics of all devices. This layer can employ techniques like meta-learning to optimize the sensing matrices based on the performance of local models and the aggregated insights from the collaboration layer.

An example learning process can involve the following steps:
Initialization: Each device can initialize its sensing matrix and trains its local model on its data.
Iterative learning: The devices can enter into an iterative process where they improve their sensing matrices based on local data, collaborate with adjacent devices to learn from collective sparse representations, and contribute to the global model's learning.
Model aggregation and update: Periodically, the global model can aggregate the learning from the devices, update the sensing matrices, and distribute the updated matrices back to the devices.

The present techniques can offer the following benefits:
Distributed sensing with multi-modal data: The present techniques can incorporate a distributed system where multi-modal data is processed, involving both an aggregator unit and individual edge devices.
Objective differentiation: The aggregator unit can focus on minimizing the reconstruction error of aggregated sensed data, while each device can aim to design a sparsifying matrix to sense data incompletely, thereby avoiding redundancy among correlated devices.
Sparsifying matrix design: Each device can design a sparsifying matrix to capture essential features of the data while leaving out some data intentionally, ensuring sparsity and reducing redundancy. The objective function for this design can involve minimizing the [symbol] ₀ norm, promoting sparsity.
Communication and correlation utilization: Devices can communicate with each other to utilize the correlated nature of their data, enhancing the performance of sparsifying matrices and overall reconstruction quality. This is achieved by sharing statistical parameters or extracted features of the data rather than the raw data itself, preserving privacy and reducing communication overhead.
Hierarchical optimization problem: The present techniques can balance the local objectives of individual devices (designing sparsifying matrices) with the global objective of the aggregator (minimizing reconstruction error). The complete optimization problem can incorporate regularization parameters to control the trade-off between sparsity, reconstruction accuracy, and data correlation utilization.
Iterative solution approach: Given the non-convex nature and interdependencies between variables in the optimization problem, iterative algorithms such as alternating minimization or gradient descent methods can be employed. This can involve iteratively updating the sparsifying matrices for each device based on local data and communicated information, and updating the reconstruction function at the aggregator based on received sparse representations.
Privacy preservation and reduced communication overhead: The approach of sharing statistical parameters or extracted features rather than raw data can help in preserving privacy and reducing communication overhead, which can be important in distributed systems.
Mathematical framework: For some examples, a comprehensive mathematical formulation is provided, detailing the objectives, constraints, and optimization problem for both the aggregator and individual devices, highlighting the intricate balance between local and global optimization goals.

The present techniques can facilitate multi-modal sparsity learning. In this approach, dynamic sparsity learning can be new relative to prior approaches. It can involve the creation of adaptive sparsifying matrices that are responsive to the specific characteristics of the data and the needs of the application. Prior data compression techniques generally apply a fixed set of rules or algorithms, leading to less efficient data representation. However, with dynamic sparsity learning, these matrices can be generated based on multi-modal data descriptors, which can describe various aspects of the data and the requirements of the application using the data.

This adaptability can enable a system that implements the present techniques to encourage sparsity in data representations, meaning it can aim to represent data with as few non-zero entries as possible. The significance of this can be two-fold: it can reduce redundancy in the data transmitted between devices, which can optimize the use of available bandwidth, and it can also enhance data privacy. Transmitting only essential information can not only conserve bandwidth resources, but can also reduce the risk of exposing sensitive data to unauthorized parties.

This technique can ensure that only essential and non-sensitive data is exchanged among devices, making data transmission, and processing, efficient and secure, particularly in environments with diverse and varying device characteristics. This can be valuable in edge computing scenarios where computational resources and connectivity can be limited, and efficient data handling can be vital.

The present techniques can facilitate correlation utilization and a knowledge graph for incomplete data sensing. That is, the present techniques can incorporate a device-centric knowledge graph (KG) and an efficient utilization of correlations among devices. The KG can function as a map that highlights the relationships between devices based on the similarities and correlations in their data. It can focus on neighboring nodes or devices sharing correlated data, enabling a system that implements the present techniques to identify and leverage these relationships effectively.

This approach offers two benefits. Firstly, it enhances the accuracy of data reconstruction. By utilizing correlations, the system can reconstruct data more precisely by incorporating information from related devices. Secondly, it reduces communication overhead. Instead of transmitting redundant information between correlated devices, the system intelligently chooses which data to share, conserving network resources.

The correlation utilization unit plays a critical role in enforcing threshold-based reconstruction error limits for each device. This means that the system ensures that the accuracy of data reconstruction for each device remains within acceptable bounds, maintaining data quality and reliability across the network.

In summary, the combination of the KG and correlation utilization represents an innovative approach that optimizes the overall network performance and data processing efficiency. It not only improves data accuracy but also reduces unnecessary data transmission, resulting in a more efficient and responsive network, particularly beneficial in scenarios with complex device relationships.

The present techniques can facilitate large language model (LLM)-compressed sensing integration for enhanced distributed sensing. The present techniques can integrate LLMs with compressed sensing techniques to advance distributed data sensing and processing. LLMs can contribute adaptability in interpreting complex data patterns, elevating the intelligence of distributed sensing systems. This integration can allow for dynamic adjustment of sensing parameters, optimizing resource allocation and reducing latency through adaptive learning. By leveraging advanced techniques in compressed sensing, a system that implements the present techniques can achieve high-fidelity signal reconstruction from intentionally incomplete data, thereby enhancing overall reliability and performance. This fusion of LLMs and compressed sensing can represent an improvement distributed data sensing, offering capabilities for real-time adjustments, efficient resource utilization, and robust signal reconstruction.

There are prior approaches in addressing the challenges of data sensing and transmission in distributed edge computing environments. Traditional data compression techniques, such as lossless and lossy compression methods (like Huffman coding, Run-Length Encoding (RLE), and Joint Photographic Experts Group (JPEG) Moving Pictures Experts Group (MPEG) for media files), have been used. While these approaches are efficient for specific data types, their static nature can limit their adaptability to the dynamic, diverse nature of data generated at the edge. There are prior approaches using techniques employing fixed sparsifying matrices; however, these approaches also lack the flexibility to adapt to changing data characteristics and requirements in real-time, making them less efficient in environments where data patterns and structures are constantly evolving. Furthermore, these prior approaches do not effectively address the challenges of data sparsity and noise prevalent in edge-generated data, often resulting in suboptimal data reconstruction and transmission efficiency.

In prior approaches, standard federated learning approaches have been used in managing distributed data. These approaches can involve training models on decentralized data, allowing for learning processes that respect user privacy and minimize data transmission. However, prior approaches to federated learning frameworks typically do not account for the unique challenges posed by edge computing, such as handling incomplete or noisy data and efficiently capturing cross-correlations between multi-device data. Moreover, these models can often require substantial communication overhead, which can be a bottleneck in bandwidth-constrained edge environments. Existing federated learning methods can also struggle with maintaining model accuracy and consistency when faced with heterogeneous data distributions and intermittent device availability, further limiting their applicability in real-world edge scenarios.

In prior approaches, the integration of adaptive learning mechanisms and real-time data adjustment capabilities generally have not been explored, leaving a gap in the efficient management of edge data characteristics. In summary, while prior approaches have generally addressed data processing and model training in distributed networks, they often fall short of dynamically adapting to the unique, evolving nature of edge environments. The limitations in handling sparsity efficiently, the lack of adaptability in compression techniques, and the communication overhead in federated learning frameworks highlight the needs addressed in the present techniques. The present techniques can be implemented to facilitate intelligently managing incomplete data, leveraging data correlations, and reducing bandwidth usage, all while enhancing data privacy and system responsiveness.

In some examples, the present techniques can be implemented as follows. In a distributed system with multi-modal data, a formulation can involve defining the objectives for the aggregator unit and the individual devices. The aggregator unit can aim to minimize the reconstruction error of the aggregated sensed data, while each device can focus on designing a sparsifying matrix to sense data incompletely, thereby avoiding redundancy among correlated devices. This approach can enhance efficiency by leveraging adaptive sparsity and dynamic correlations, which prior approaches can fail to address effectively.

A mathematical formulation of the process can be as follows:
Aggregator unit: The data collected by device i can be denoted as xᵢ, and the sparsifying matrix used by device i can be denoted as Sᵢ. The sensed data by device i is then Sᵢxᵢ.
The aggregator unit can aim to reconstruct the original signal from the sparsely sensed data from N devices. The reconstruction can be represented as

$$R ( {\sum }_{i = 1}^{N} {S}_{i} {x}_{i} )$$

where R is the reconstruction function. The goal of the aggregator can be to minimize the aggregator's reconstruction error. The objective function can be formulated as:

$${min}_{R , {S}_{i}} {‖ X - R ( {\sum }_{i = 1}^{N} {S}_{i} {x}_{i} ) ‖}^{2} ,$$

where X=[x₁, . . . , x_{N}] can be aggregated data across different devices. This can represent a least squares problem, aiming to minimize the difference between the original data and the reconstructed data from the sparse representations.
Individual devices: Each device can aim to design a sparsifying matrix Sᵢ that captures the essential features of the data while intentionally leaving out some data to ensure sparsity and reduce redundancy. The objective for each device can be formulated as

$${min}_{R , {S}_{i}} {‖ {S}_{i} {x}_{i} ‖}_{0}$$

$$s . t . {‖ {x}_{i} - R ( {S}_{i} {x}_{i} ) ‖}^{2} \leq T .$$

Here, ∥Sᵢxᵢ∥₀ represents the [symbol] ₀ norm, which counts the number of non-zero entries (encouraging sparsity), and Tᵢ is a threshold for the acceptable reconstruction error for device i enforced by correlation utilization unit, which is explained below.

Devices can communicate with each other to utilize the correlated nature of their data, enhancing the performance of the sparsifying matrices and the overall reconstruction quality. This approach can be done by sharing certain statistical parameters or features of the data rather than the raw data itself, thereby preserving privacy and reducing communication overhead. The communication, formulated as an optimization problem, can aim to enhance the sparsifying matrices based on the correlation of data from different devices, showcasing an approach for distributed edge computing:

$${min}_{{S}_{1} , … , {S}_{N}} {\sum }_{i = 1}^{N} {\sum }_{j = 1 , j \neq i}^{N} Δ ( {S}_{i} {x}_{i} , {S}_{j} {x}_{j} )$$

Here, Δ(·,·) is a function measuring the dissimilarity or redundancy between the sparse representations of data from different devices. The objective here is to minimize this redundancy, encouraging the sparsifying matrices to capture complementary aspects of the data.

The overall system can aim to balance the local objectives of individual devices (designing sparsifying matrices) with the global objective of the aggregator (minimizing reconstruction error). The complete optimization problem can be formulated as:

$${min}_{{S}_{1} , … , {S}_{N} , R} \{ {‖ X - R ( {\sum }_{i = 1}^{N} {S}_{i} {x}_{i} ) ‖}^{2} + {λ}_{1} {‖ {S}_{i} {x}_{i} ‖}_{0} + {λ}_{2} {\sum }_{i = 1}^{N} {( {‖ {x}_{i} - R ( {S}_{i} {x}_{i} ) ‖}^{2} - {T}_{i} )}^{2} + γ {\sum }_{i = 1}^{N} {\sum }_{j = 1 , j \neq i}^{N} Δ ( {S}_{i} {x}_{i} , {S}_{j} {x}_{j} ) \}$$

In this formulation, λ₁, λ₂ and γ are regularization parameters that control the trade-off between sparsity, reconstruction accuracy, and utilization of data correlation.

Solving the above optimization problem can be complex due to its non-convex nature and the interdependencies between the variables. Iterative algorithms, such as alternating minimization or gradient descent methods, can be employed. The process can generally involve iteratively updating Sᵢ for each device based on local data and communicated information and updating R at the aggregator based on the received sparse representations.

This mathematical formulation can provide a comprehensive framework for designing a distributed system with multi-modal data where the aggregator minimizes reconstruction error, and individual devices design sparsifying matrices to sense data sparsely and incompletely, leveraging the redundancy in correlated data.

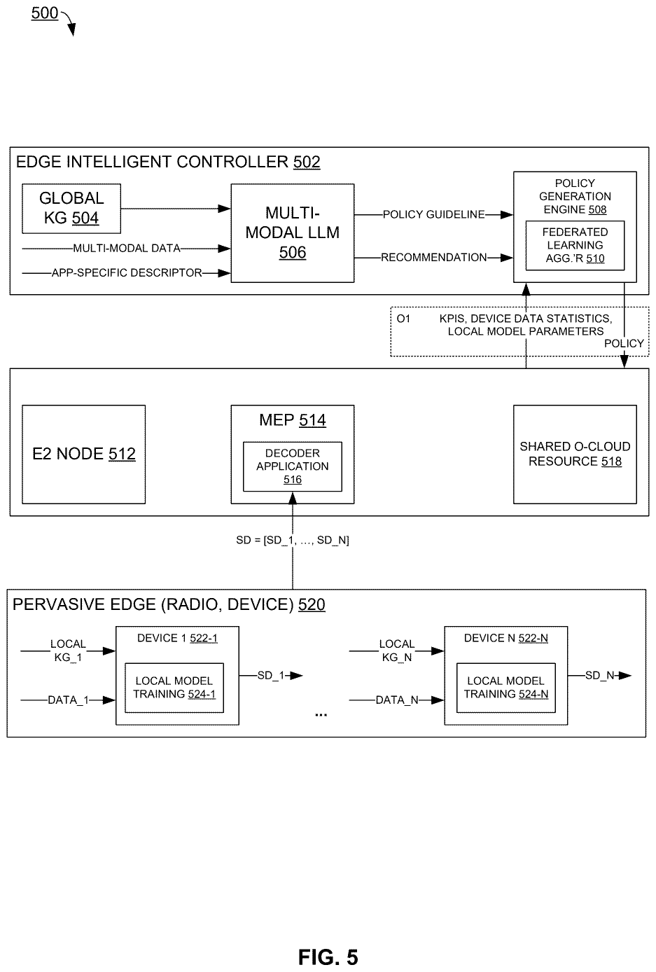

Deploying a global multi-modal LLM at the core network to manage and optimize a distributed system with multi-modal data can involve several components working in unison as depicted in FIG. 5. The LLM can act as a central intelligence unit that oversees policy generation, the identification of device correlations, and the synchronization of models across the network. The following presents this in greater detail.

Clustering and KG construction can be implemented as follows:
Device clustering: Use clustering algorithms to group devices based on the similarity of their data or their physical proximity. This can form the basis for identifying devices with correlated data.
KG construction: Construct a clustered KG where each node represents a device or a cluster of devices, and edges represent the degree of correlation between their data. This graph can help the LLM understand the structure and relationships within the network, guiding the policy generation process.

Global multi-modal LLM deployment can be implemented as follows:

LLM Integration: Integrate the LLM into the core network, such that it has access to multi-modal data and application requirements descriptors. This data can provide the context the LLM needs to generate effective policies. The input and output for LLM unit can be as follows:

### Input:

Global KG: Represents the relationships, correlations, and dependencies among devices and their data, providing a rich context for policy generation.
Multi-modal data descriptors: Detailed information about the nature, format, and characteristics of the data collected by the devices.
Application requirements: Information about the specific needs of the application, including accuracy, latency, privacy concerns, and any other relevant operational parameters.
Feedback from distributed learning: Insights and updates from the distributed learning process to refine the policy generation based on real-world performance and data.

### Output:

Policy guidelines: High-level strategies and guidelines for data sensing, processing, and communication, considering the multi-modal nature of the data, application requirements, and the insights from the KG.
Recommendations for sparsifying matrices and reconstruction functions: Preliminary suggestions or constraints for designing the sparsifying matrices and the data reconstruction functions, informed by the KG.

Policy generator engine: The LLM can act as a policy generator unit. It can process the multi-modal data descriptors and application requirements to learn and generate sparsifying matrices for devices with correlated data. This can minimize redundancy and optimize the network's overall data transmission and processing efficiency. The inputs and outputs for the policy generator engine can be as follows:

### Input:

LLM outputs: Policy guidelines and recommendations from the LLM, including insights derived from the KG.
Device data statistics: Aggregated data or statistics from the devices to understand the data distribution, volume, and other characteristics without compromising privacy.
Performance metrics: Information about the current performance of the system, including reconstruction errors and the efficiency of data transmission and processing.

### Output:

Sparsifying matrix policies: Specific policies or parameters for designing sparsifying matrices for each device or cluster of devices, considering the insights from the KG.
Reconstruction function policies: Specific policies or parameters for the data reconstruction function at the aggregator unit, also informed by the KG.

Policy enforcement on devices and distributed units (DUs) can be implemented as follows:

Sparsifying matrices learning: Based on the policies generated by the LLM, select appropriate sparsifying matrices for each device or cluster of devices. This selection process can be informed by the device correlations identified in the KG. The inputs and outputs can be as follows:

### Input:

Sparsifying matrix policies from policy generator: Specific guidelines and constraints for designing the sparsifying matrices, considering the insights from the KG.
Local device data: Data available at each device, used to learn and adapt the sparsifying matrices locally.
Local KG: A device-centric KG that can include only the neighboring nodes which have data correlated to that of the original device.

### Output:

Learned sparsifying matrices: Optimized sparsifying matrices for each device, designed to capture the essential features of the data while promoting sparsity and reducing redundancy, informed by the KG.

Global multi-modal LLM deployment can be implemented as follows:

Decoding processors: Deploy decoding processors at the DUs or edge devices. These processors can be responsible for reconstructing the original data from the sparsely sensed data using the decoding matrices complementary to the sparsifying matrices. Inputs and outputs can be as follows:

### Input:

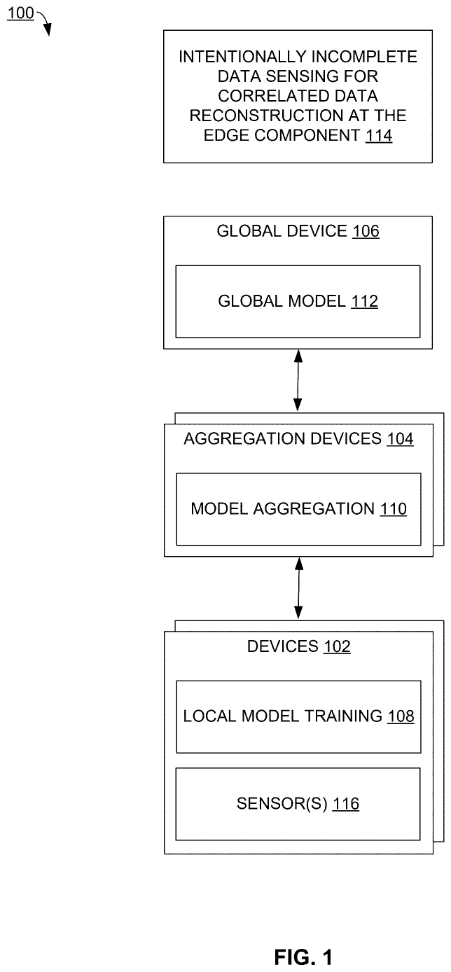

Reconstruction function policies from policy generator: Specific guidelines and constraints for designing the reconstruction function, considering insights from the KG.
Sparsely sensed data from Devices: The data collected by N devices, as depicted in FIG. 1 after being processed by the sparsifying matrices, is represented as sd=[sd₁, . . . , sd_{N}].

### Output:

Reconstructed data: The original data signal reconstructed from the sparsely sensed data, aiming to minimize the reconstruction error and informed by the structure and correlations represented in the KG.

Synchronization: Ensure that wireless devices and DUs are synchronized regarding which sparsifying and decoding matrices are being used. This can be achieved through a signaling protocol or by embedding synchronization information in the data packets.

Distributed learning for policy improvement can be implemented as follows:
Local policy model training: Allow devices to train local policy models based on the sparsifying matrices and their local data characteristics. These local models can aim to further optimize the data sensing and transmission based on real-time data and operational conditions.
Model aggregation: Periodically, aggregate these local models in the core network using distributed learning principles. This can help in updating the global policy model while preserving data privacy and reducing communication overhead.

Model synchronization and update can be implemented as follows:
Downloading local policy models: Wireless devices can download the latest local policy models from the core network or DUs. These models can be aligned with the global policy model, and are fine-tuned to the devices' specific data characteristics and operational conditions.
Global model update: When the global model is updated based on aggregated insights from the distributed learning process, push these updates to the devices and DUs. This can ensure that all components in the network are using the most up-to-date policies and matrices.
Continuous learning and adaptation: Implement mechanisms for continuous learning and adaptation. As devices operate and gather more data, they can continuously refine their local models and contribute to the refinement of the global model through the distributed learning framework.

By following this approach according to the present techniques, a global multi-modal LLM deployed at the core network can effectively manage and optimize a distributed system with multi-modal data. The use of clustering and KGs can help in identifying correlations and redundancies, while distributed learning ensures continuous improvement and synchronization of policies across the network. This holistic approach can ensure efficient data sensing, transmission, and processing, adapting dynamically to changing data patterns and network conditions.

Mapping the concept of deploying a global LLM to manage a distributed system with multi-modal data onto the above mathematical formulation can involve aligning the functional components of the LLM-based system with the objectives and constraints of the mathematical problem. In some examples, the mapping can be implemented as follows:

### Policy Generator Unit as Aggregator:

The policy generator unit, powered by the LLM, can assume the role of the aggregator unit in the mathematical formulation. It can generate policies, and also oversee a reconstruction process to minimize an error between the original data and the reconstructed data.
The policy generator's role as an aggregator can align with the objective function of the aggregator unit, focusing on minimizing the reconstruction error:

$${min}_{R , {S}_{i}} {‖ X - R ( {\sum }_{i = 1}^{N} {S}_{i} {x}_{i} ) ‖}^{2} .$$

### Policy Generator Unit for Learning Sparsifying Matrices:

The policy generator unit can handle designing and optimizing the sparsifying matrices Sᵢ for each device. This can involve analyzing the multi-modal data, understanding device correlations, and generating matrices that effectively capture the essential features of the data while promoting sparsity.
The policy generator's role in learning sparsifying matrices can map to the local objectives of individual devices in the mathematical formulation:

$${min}_{R , {S}_{i}} {‖ {S}_{i} {x}_{i} ‖}_{0}$$

subject to ∥xᵢ−R(Sᵢxᵢ)∥²≤Tᵢ.

### Clustering and KG Construction:

Clustering devices and constructing a KG remains crucial for identifying device correlations and informing the policy generation process.
The construction of a KG and device clustering can be implemented for the policy generator to understand device correlations and effectively generate sparsifying matrices, aligning with the communication optimization problem:

$${min}_{{S}_{1} , … , {S}_{N}} {\sum }_{i = 1}^{N} {\sum }_{j = 1 , j \neq i}^{N} Δ ( {S}_{i} {x}_{i} , {S}_{j} {x}_{j} )$$

### Synchronization and Model Updates:

The policy generator unit can ensure that the sparsifying matrices and reconstruction functions are consistently updated and synchronized across the network, aligning with the global and local optimization objectives.
Synchronization can ensure that the updates to sparsifying matrices Sᵢ and the reconstruction function R by the policy generator are effectively propagated throughout the system, maintaining the integrity of the optimization process as described in the overall problem formulation.

### Federated Learning for Policy Enhancement:

The policy generator unit can benefit from distributed learning mechanisms, allowing it to aggregate insights from local models, continuously improve the sparsifying matrices and reconstruction functions, and align with the distributed nature of the system.
Federated learning can align with the iterative solution approach in the mathematical formulation, enabling the policy generator unit to iteratively refine Sᵢ and R, balancing local objectives (device-specific sparsity) and the global objective (minimized reconstruction error).

In this modified structure, the policy generator unit, empowered by the LLM, can take a role in the distributed system, addressing both the aggregator unit's functionality and the learning of sparsifying matrices. It can become a focal point for managing the optimization process, ensuring the system's overall efficiency and coherence in handling multi-modal data.

In examples of the present techniques, the policy engine and local model training are not based on large language models (LLMs). Instead, a federated learning approach can be used, such as a federated proximal technique, which can allow devices to train models locally and share policy updates efficiently. This approach can be lightweight, so utilizing it can avoid feasibility issues that can be associated with deploying large models directly on edge devices. Each device can handle its own local training, so it can be that there is no significant burden on the device in terms of model size or processing requirements. Additionally, according to the present techniques, a multi-modal LLM can sit at the edge, rather than directly on each device. This LLM can provide high-level guidance to the policy generation engine-such as initializing sparsifying matrices for different clusters of devices based on the specific types of data they are sensing. In cases where an LLM-based policy generation engine can be advantageous, the present techniques offer flexibility by designing a system to support small, efficient LLMs that comprise a compact model optimized for edge deployment.

Regarding fine-tuning, rather than relying on prior approaches for LLM fine-tuning, the present techniques can use a rule-based knowledge graph (KG) to help structure data dependencies and manage correlations between different device data types. This KG can act as a map of relationships, showing dependencies and correlations across devices and data domains. With this structured approach, the KG can facilitate capturing key patterns and correlations needed for tasks like predicting sparsity or understanding cross-device relationships—without requiring complex fine-tuning typically associated with LLMs.

### Example Architectures, Etc.

FIG. 1 illustrates an example system architecture 100 that can facilitate intentionally incomplete data sensing for correlated data reconstruction at the edge, in accordance with an embodiment of this disclosure.

System architecture 100 comprises devices 102, aggregation devices 104, global device 106, local model training 108, model aggregation 110, global model 112, intentionally incomplete data sensing for correlated data reconstruction at the edge component 114, and sensor(s).

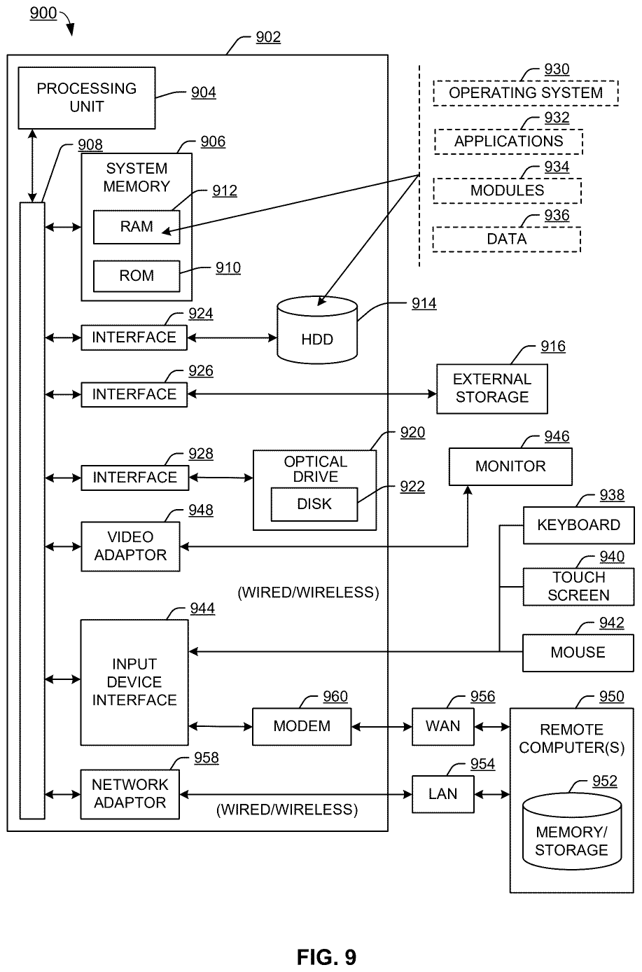

Each of devices 102, aggregation devices 104, and/or global device 106 can be implemented with part(s) of computing environment 900 of FIG. 9.

Each device of devices 102 can train a local model (local model training 108) to learn a sparsifying matrix for representing data captured/sensed from an instance of sensor(s) 116. These local trained models of devices that share physical proximity can be aggregated by different instances of aggregation devices 104 (as model aggregation 110). These multiple aggregations can be used by global device 106 to generate global model 112, and global model 112 can be used to update instances of local model training 108. This can all be facilitated by intentionally incomplete data sensing for correlated data reconstruction at the edge component 114.

This can be considered a three-level hierarchical architecture, with the three levels being the local device level (devices 102), the aggregation level (aggregation devices 104), and the global level (global device 106).

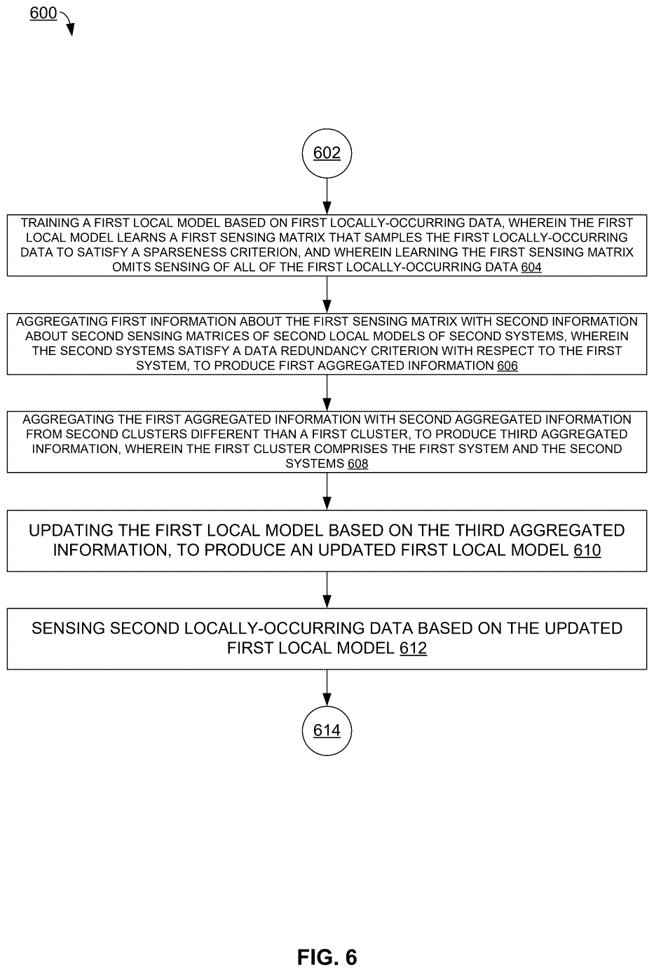

In some examples, intentionally incomplete data sensing for correlated data reconstruction at the edge component 114 can implement part(s) of the process flows of FIGS. 6-8 to implement intentionally incomplete data sensing for correlated data reconstruction at the edge.

It can be appreciated that system architecture 100 is one example system architecture for intentionally incomplete data sensing for correlated data reconstruction at the edge, and that there can be other system architectures that facilitate intentionally incomplete data sensing for correlated data reconstruction at the edge.

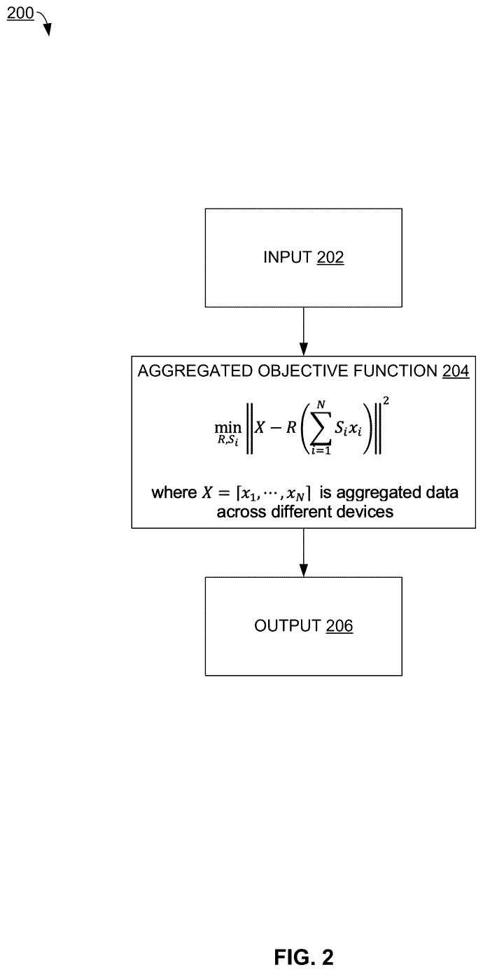

FIG. 2 illustrates an example of an objective function, and that can facilitate intentionally incomplete data sensing for correlated data reconstruction at the edge, in accordance with an embodiment of this disclosure. In some examples, part(s) of example 200 can be implemented by part(s) of system architecture 100 of FIG. 1 to facilitate intentionally incomplete data sensing for correlated data reconstruction at the edge.

Example 200 comprises input 202, aggregated objective function 204, and output 206. Input 202 can comprise sensed data from devices. Aggregated objective function 204 can have a goal of minimizing a reconstruction error associated with reconstructing the original signal from the sparsely sensed data in input 202. Output 206 can comprise this reconstruction error.

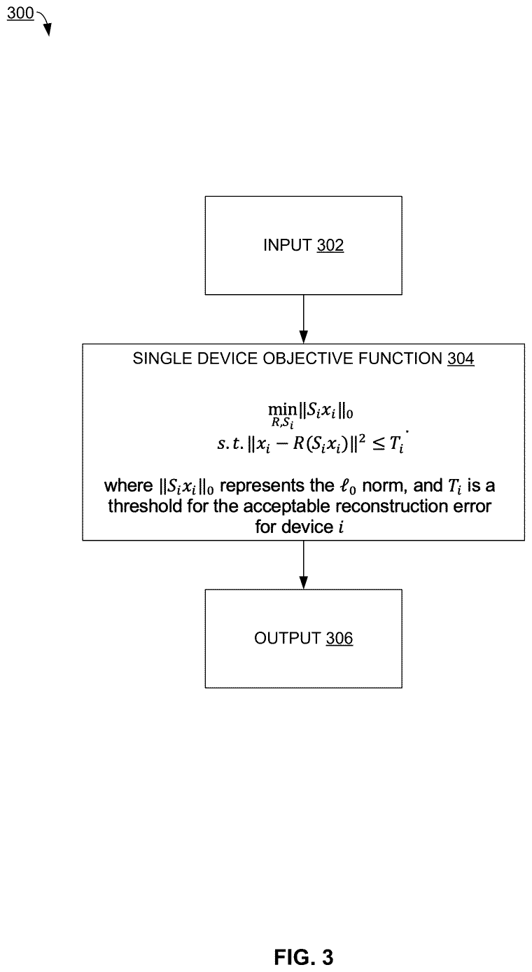

FIG. 3 illustrates an example of an objective of each device of a group of devices, and that can facilitate intentionally incomplete data sensing for correlated data reconstruction at the edge, in accordance with an embodiment of this disclosure. In some examples, part(s) of example 200 can be implemented by part(s) of system architecture 100 of FIG. 1 to facilitate intentionally incomplete data sensing for correlated data reconstruction at the edge.

Example 300 comprises input 302, single device objective function 304, and output 306. Input 302 can comprise sensed data by a device. Single device objective function 304 can have a goal of minimizing the number of nonzero entries in a sensing matrix (which can encourage sparsity in the matrix). Output 306 can comprise the number of nonzero entries.

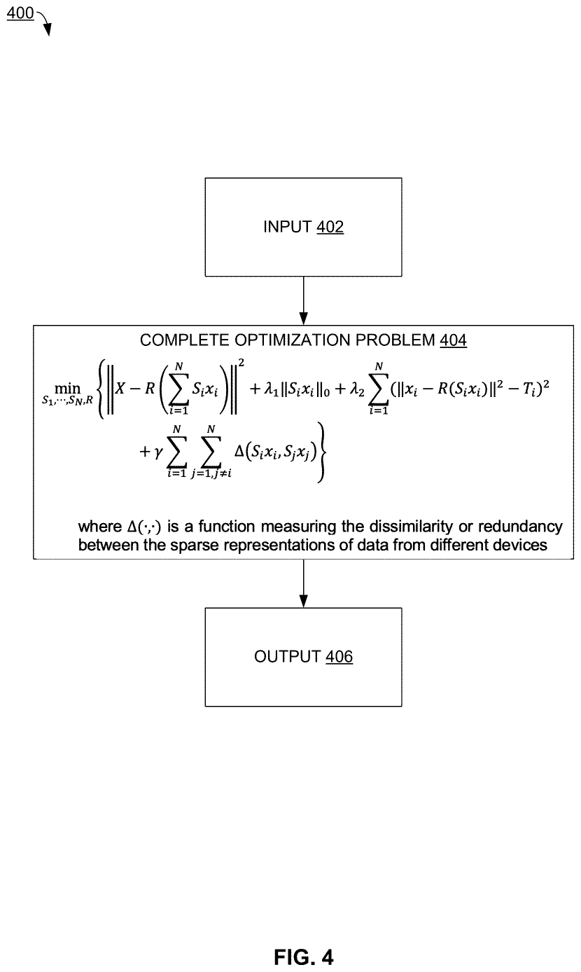

FIG. 4 illustrates an example of a complete optimization problem, and that can facilitate intentionally incomplete data sensing for correlated data reconstruction at the edge, in accordance with an embodiment of this disclosure. In some examples, part(s) of example 200 can be implemented by part(s) of system architecture 100 of FIG. 1 to facilitate intentionally incomplete data sensing for correlated data reconstruction at the edge.

Example 400 comprises input 402, complete optimization problem 404, and output 406.

Input 402 can comprise sensed data from devices. Complete optimization problem 404 can have a goal of finding an acceptable (or optimal) tradeoff between sparsity, reconstruction accuracy, and utilization of data correlation. Output 406 can comprise the result of complete optimization problem 404.

FIG. 5 illustrates another example system architecture that can facilitate intentionally incomplete data sensing for correlated data reconstruction at the edge, in accordance with an embodiment of this disclosure. In some examples, part(s) of system architecture 500 can be implemented by part(s) of system architecture 100 of FIG. 1 to facilitate intentionally incomplete data sensing for correlated data reconstruction at the edge.

System architecture 500 comprises edge intelligent controller 502, global KG 504, multi-modal LLM 506, policy generation engine 508, federated learning aggregator 510, E2 node 512, management and orchestration (M&O) edge platform (MEP) 514, decoder application 516, shared O-cloud resource 518, pervasive edge (radios, devices) 520, device 1 522-1, device N 522-N, local model training 524-1, and local model training 524-N.

There can be multiple instances of devices (e.g., device 1 522-1, device N 522-N), each having its own local model that it trains (e.g., local model training 524-1, local model training 524-N).

Local training of local models can be aggregated by decoder application 516. In some examples, multiple instances of this can occur, such as with multiple groups of local devices that are physically proximal to each other.

Instances of the aggregated local model training can be used by edge intelligent controller 502 to perform global model training, and this global model training can be used to update the local models (e.g., respective local models of device 1 522-1 and device N 522-N).

### Example Process Flows

FIG. 6 illustrates an example process flow 600 that can facilitate intentionally incomplete data sensing for correlated data reconstruction at the edge, in accordance with an embodiment of this disclosure. In some examples, one or more embodiments of process flow 600 can be implemented by intentionally incomplete data sensing for correlated data reconstruction at the edge component 114 of FIG. 1, or computing environment 900 of FIG. 9.

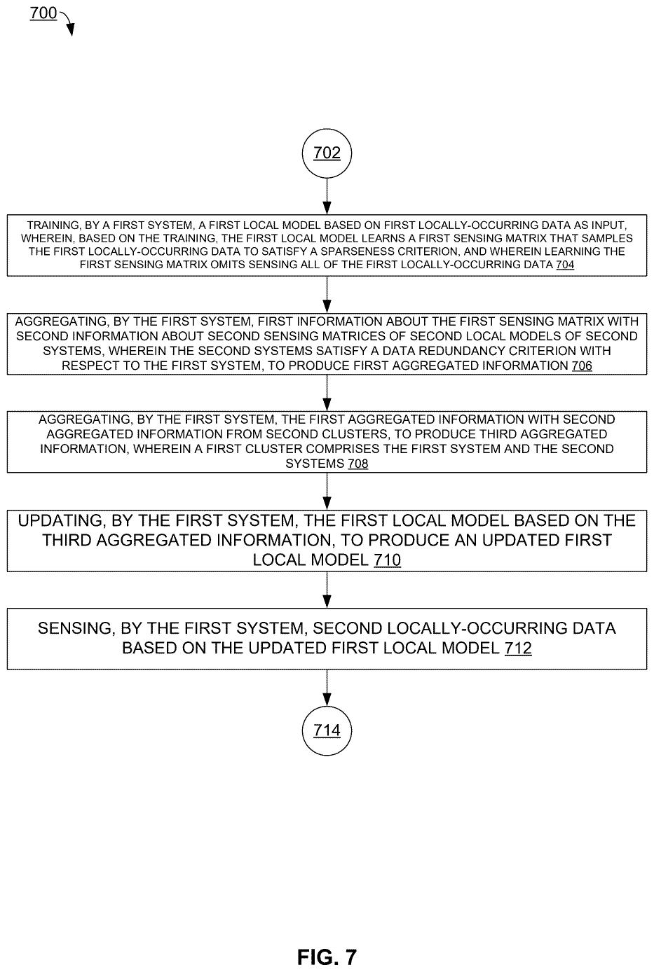

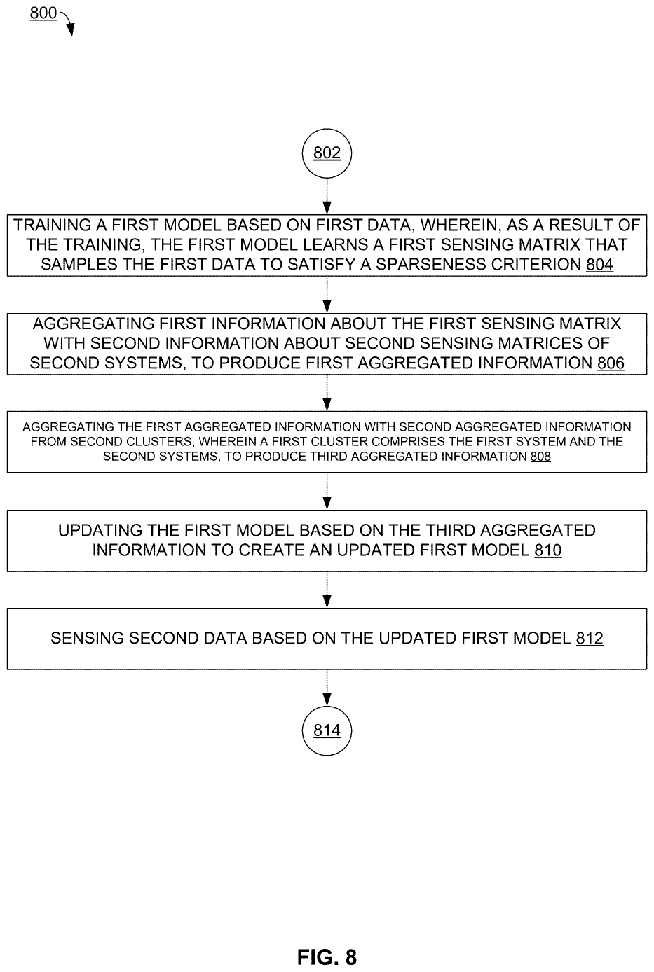

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 700 of FIG. 7, and/or process flow 800 of FIG. 8.

Process flow 600 begins with 602, and moves to operation 604.

Operation 604 depicts training a first local model based on first locally-occurring data, wherein the first local model learns a first sensing matrix that samples the first locally-occurring data to satisfy a sparseness criterion, and wherein learning the first sensing matrix omits sensing of all of the first locally-occurring data. Using the example of FIG. 1, the first local model can be local model training 108, where the first locally-occurring data can be acquired from sensor(s) 116.

Learning a sensing matrix can be part of model inference. Inference can incorporate a knowledge graph, including data types and sparsifying matrices.

In some examples, the first sensing matrix satisfies a data-criticality criterion. In some examples, the first sensing matrix satisfies a data-incompleteness criterion. That is, a local layer can focus on capturing the most critical and representative features of local data while insuring sparsity and intentional data incompleteness.

In some examples, operation 604 comprises iteratively training the first local model on refreshes of the first locally-occurring data, to produce iterations of the first local model. In some examples, operation 604 comprises iteratively performing the aggregating of the first information with the second information, based on the iterations of the first local model, to produce iterations of the first aggregated information. That is, devices can enter into an iterative process where they improve their sensing matrices based on local data, collaborate with adjacent devices to learn from collective sparse representations, and contribute to the global model's learning.

After operation 604, process flow 600 moves to operation 606.

Operation 606 depicts aggregating first information about the first sensing matrix with second information about second sensing matrices of second local models of second systems, wherein the second systems satisfy a data redundancy criterion with respect to the first system, to produce first aggregated information. Continuing with the example of FIG. 1, this aggregating can occur in model aggregation 110 at aggregation devices 104.

In some examples, inter-cluster aggregation can occur at an edge device.

In some examples, the first system and the second systems within the first cluster satisfy an adjacency criterion defining an adjacency between the first system and the second systems. In some examples, the aggregating of the first information about the first sensing matrix with the second information about the second sensing matrices omits transmitting the first locally-occurring data, and omits receiving the second locally-occurring data used to generate the second sensing matrices. That is, at a collaboration layer, adjacent devices can be formed into clusters to collaboratively share and aggregate their learning. In the collaboration layer, devices can exchange information about their sensing matrices and the sparse representations of their data. A goal can be to learn from the collective data without transmitting raw data, and minimizing bandwidth usage.

In some examples, the aggregating of the first information about the first sensing matrix with the second information about the second sensing matrices comprises performing meta-learning. A global model can aggregate insights from all clusters. It can fine-tune sensing matrices to ensure they are well-adapted to the collective data characteristics of all devices. This layer can employ advanced techniques like meta-learning to optimize the sensing matrices based on the performance of local models and the aggregated insights from the collaboration layer.

After operation 606, process flow 600 moves to operation 608.

Operation 608 depicts aggregating the first aggregated information with second aggregated information from second clusters different than a first cluster, to produce third aggregated information, wherein the first cluster comprises the first system and the second systems. Continuing with the example of FIG. 1, this aggregating can occur at global model 112 of global device 106.

The global layer can receive sensed data from devices from a collaboration layer, which can have access to sparsifying matrices of the devices that it aggregates.

In some examples, the aggregating of the first aggregated information with the second aggregated information comprises iteratively aggregating the iterations of the first aggregated information with iterations of the second aggregated information, to produce iterations of the third aggregated information. In some examples, the updating of the first local model based on the third aggregated information comprises iteratively updating the first local model based on the iterations of the third aggregated information. That is, the global model can periodically the learning from all devices, updates the sensing matrices, and distributes the updated matrices back to the devices.

After operation 608, process flow 600 moves to operation 610.

Operation 610 depicts updating the first local model based on the third aggregated information, to produce an updated first local model. Continuing with the example of FIG. 1, this can comprise updating a local model of a device of devices 102 based on global model 112.

After operation 610, process flow 600 moves to operation 612.

Operation 612 depicts sensing second locally-occurring data based on the updated first local model. Continuing with the example of FIG. 1, this can comprise a device of devices 102 using the updated local model of operation 610 to perform an inference on data acquired from sensor(s) 116.

After operation 612, process flow 600 moves to 614, where process flow 600 ends.

FIG. 7 illustrates an example process flow 700 that can facilitate intentionally incomplete data sensing for correlated data reconstruction at the edge, in accordance with an embodiment of this disclosure. In some examples, one or more embodiments of process flow 700 can be implemented by intentionally incomplete data sensing for correlated data reconstruction at the edge component 114 of FIG. 1, or computing environment 900 of FIG. 9.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 600 of FIG. 6, and/or process flow 800 of FIG. 8.

Process flow 700 begins with 702, and moves to operation 704.

Operation 704 depicts training, by a first system, a first local model based on first locally-occurring data as input, wherein, based on the training, the first local model learns a first sensing matrix that samples the first locally-occurring data to satisfy a sparseness criterion, and wherein learning the first sensing matrix omits sensing all of the first locally-occurring data. In some examples, operation 704 can be implemented in a similar manner as operation 604 of FIG. 6.

After operation 704, process flow 700 moves to operation 706.

Operation 706 depicts aggregating, by the first system, first information about the first sensing matrix with second information about second sensing matrices of second local models of second systems, wherein the second systems satisfy a data redundancy criterion with respect to the first system, to produce first aggregated information. In some examples, operation 706 can be implemented in a similar manner as operation 606 of FIG. 6.

In some examples, the aggregating of the first information with the second information satisfies a minimized reconstruction error of aggregated sensed data criterion. In some examples, the first sensing matrix satisfies the data redundancy criterion with respect to the second sensing matrices. That is, an aggregator unit can focus on minimizing the reconstruction error of aggregated sensed data, while each device can aim to design a sparsifying matrix to sense data incompletely, thereby avoiding redundancy among correlated devices.

In some examples, the first information about the first sensing matrix comprises a statistical parameter of the first locally-occurring data, or an extracted feature of the first locally-occurring data. That is, devices can communicate with each other to utilize the correlated nature of their data, enhancing the performance of sparsifying matrices and overall reconstruction quality. This can be achieved by sharing statistical parameters or extracted features of the data rather than the raw data itself, preserving privacy and reducing communication overhead.

After operation 706, process flow 700 moves to operation 708.

Operation 708 depicts aggregating, by the first system, the first aggregated information with second aggregated information from second clusters, to produce third aggregated information, wherein a first cluster comprises the first system and the second systems. In some examples, operation 708 can be implemented in a similar manner as operation 608 of FIG. 6.

After operation 708, process flow 700 moves to operation 710.

Operation 710 depicts updating, by the first system, the first local model based on the third aggregated information, to produce an updated first local model. In some examples, operation 710 can be implemented in a similar manner as operation 610 of FIG. 6. After operation 710, process flow 700 moves to operation 712.

Operation 712 depicts sensing, by the first system, second locally-occurring data based on the updated first local model. In some examples, operation 712 can be implemented in a similar manner as operation 612 of FIG. 6.

After operation 712, process flow 700 moves to 714, where process flow 700 ends.

FIG. 8 illustrates an example process flow 800 that can facilitate intentionally incomplete data sensing for correlated data reconstruction at the edge, in accordance with an embodiment of this disclosure. In some examples, one or more embodiments of process flow 800 can be implemented by intentionally incomplete data sensing for correlated data reconstruction at the edge component 114 of FIG. 1, or computing environment 900 of FIG. 9.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 600 of FIG. 6, and/or process flow 700 of FIG. 7.

Process flow 800 begins with 802, and moves to operation 804.

Operation 804 depicts training a first model based on first data, wherein, as a result of the training, the first model learns a first sensing matrix that samples the first data to satisfy a sparseness criterion. In some examples, operation 804 can be implemented in a similar manner as operation 604 of FIG. 6.

After operation 804, process flow 800 moves to operation 806.

Operation 806 depicts aggregating first information about the first sensing matrix with second information about second sensing matrices of second systems, to produce first aggregated information. In some examples, operation 806 can be implemented in a similar manner as operation 606 of FIG. 6.

In some examples, operation 806 comprises selecting the second systems for the first cluster based on a knowledge graph, wherein the knowledge graph identifies respective relationships between the first system and respective second systems of the second systems based on data similarities or data correlations. That is, the present techniques can utilize a device-centric Knowledge Graph (KG) and an efficient utilization of correlations among devices. The KG can function as a map that highlights the relationships between devices based on the similarities and correlations in their data. It can focus on neighboring nodes or devices sharing correlated data, enabling the system to identify and leverage these relationships effectively.

After operation 806, process flow 800 moves to operation 808.

Operation 808 depicts aggregating the first aggregated information with second aggregated information from second clusters, wherein a first cluster comprises the first system and the second systems, to produce third aggregated information. In some examples, operation 808 can be implemented in a similar manner as operation 608 of FIG. 6.

In some examples, a local objective of training the first model comprises generating a matrix that satisfies the sparseness criterion, and a global objective of the aggregating of the first aggregated information with the second aggregated information comprises satisfying a reconstruction error minimization criterion. That is, the present techniques can balance local objectives of individual devices (designing sparsifying matrices) with a global objective of the aggregator (minimizing reconstruction error). The complete optimization problem can incorporate regularization parameters to control the trade-off between sparsity, reconstruction accuracy, and data correlation utilization.

In some examples, operation 808 comprises, based on the knowledge graph, generating, with a large language model, policy guidelines for data sensing, processing, and communication, wherein the policy guidelines are used to perform the learning of the first sensing matrix.

In some examples, operation 808 comprises, based on the knowledge graph, generating, with a large language model, constraints applicable to designing sparsifying matrices and reconstruction functions, wherein the constraints are used to perform the learning of the first sensing matrix.

that is, a global LLM can take as input a global KG, multi-modal data descriptors, application requirements, and feedback from distributed learning. The global LLM can output policy guidelines and/or recommendations for sparsifying matrices and reconstruction functions.

In some examples, operation 808 generating a policy guidance and a recommendation with a large language model, wherein the aggregating of the first aggregated information with the second aggregated information is performed based on the policy guidance and the recommendation.

After operation 808, process flow 800 moves to operation 810.

Operation 810 depicts updating the first model based on the third aggregated information to create an updated first model. In some examples, operation 810 can be implemented in a similar manner as operation 610 of FIG. 6.

After operation 810, process flow 800 moves to operation 812.

Operation 812 depicts sensing second data based on the updated first model.

In some examples, operation 812 can be implemented in a similar manner as operation 612 of FIG. 6.

After operation 812, process flow 800 moves to 814, where process flow 800 ends.

### Example Operating Environment

In order to provide additional context for various embodiments described herein, FIG. 9 and the following discussion are intended to provide a brief, general description of a suitable computing environment 900 in which the various embodiments of the embodiment described herein can be implemented.

For example, parts of computing environment 900 can be used to implement one or more embodiments of devices 102, aggregation devices 104, and/or global device 106.

In some examples, computing environment 900 can implement one or more embodiments of the process flows of FIGS. 6-8 to facilitate intentionally incomplete data sensing for correlated data reconstruction at the edge.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various embodiments described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a nonvolatile storage such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 1020 (e.g., which can read or write from a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid state drive (SSD) could be used in addition to, or in place of, an HDD 914. The HDD 914, external storage device(s) 916 and optical disk drive 1020 can be connected to the system bus 908 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 1044 that can be coupled to the system bus 908, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 908 via an interface, such as a video adapter 1048. In addition to the monitor 1046, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 1060 or can be connected to a communications server on the WAN 956 via other means for establishing communications over the WAN 956, such as by way of the Internet. The modem 1060, which can be internal or external and a wired or wireless device, can be connected to the system bus 908 via the input device interface 1044. In a networked environment, program modules depicted relative to the computer 902 or portions thereof, can be stored in the remote memory/storage device 952. It will be appreciated that the network connections shown are examples, and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 1060, respectively. Upon connecting the computer 902 to an associated cloud storage system, the external storage interface 1026 can, with the aid of the adapter 958 and/or modem 1060, manage storage provided by the cloud storage system as it would other types of external storage. For instance, the external storage interface 1026 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A first system, comprising:
at least one processor; and
at least one memory that stores executable instructions that, when executed by the at least one processor, facilitate performance of operations, comprising:
training a first local model based on first locally-occurring data, wherein the first local model learns a first sensing matrix that samples the first locally-occurring data to satisfy a sparseness criterion, and wherein learning the first sensing matrix omits sensing of all of the first locally-occurring data;
aggregating first information about the first sensing matrix with second information about second sensing matrices of second local models of second systems, wherein the second systems satisfy a data redundancy criterion with respect to the first system, to produce first aggregated information;
aggregating the first aggregated information with second aggregated information from second clusters different than a first cluster, to produce third aggregated information, wherein the first cluster comprises the first system and the second systems;
updating the first local model based on the third aggregated information, to produce an updated first local model; and
sensing second locally-occurring data based on the updated first local model.

2. The first system of claim 1, wherein the first sensing matrix satisfies a data-criticality criterion.

3. The first system of claim 1, wherein the first sensing matrix satisfies a data-incompleteness criterion.

4. The first system of claim 1, wherein the first system and the second systems within the first cluster satisfy an adjacency criterion defining an adjacency between the first system and the second systems.

5. The first system of claim 1, wherein the aggregating of the first information about the first sensing matrix with the second information about the second sensing matrices omits transmitting the first locally-occurring data, and omits receiving the second locally-occurring data used to generate the second sensing matrices.

6. The first system of claim 1, wherein the aggregating of the first information about the first sensing matrix with the second information about the second sensing matrices comprises performing meta-learning.

7. The first system of claim 1, wherein the operations further comprise:
iteratively training the first local model on refreshes of the first locally-occurring data, to produce iterations of the first local model.

8. The first system of claim 7, wherein the operations further comprise:
iteratively performing the aggregating of the first information with the second information, based on the iterations of the first local model, to produce iterations of the first aggregated information.

9. The first system of claim 8, wherein the aggregating of the first aggregated information with the second aggregated information comprises:
iteratively aggregating the iterations of the first aggregated information with iterations of the second aggregated information, to produce iterations of the third aggregated information.

10. The first system of claim 9, wherein the updating of the first local model based on the third aggregated information comprises:
iteratively updating the first local model based on the iterations of the third aggregated information.

11. A method, comprising:
training, by a first system comprising at least one processor, a first local model based on first locally-occurring data as input, wherein, based on the training, the first local model learns a first sensing matrix that samples the first locally-occurring data to satisfy a sparseness criterion, and wherein learning the first sensing matrix omits sensing all of the first locally-occurring data;
aggregating, by the first system, first information about the first sensing matrix with second information about second sensing matrices of second local models of second systems, wherein the second systems satisfy a data redundancy criterion with respect to the first system, to produce first aggregated information;
aggregating, by the first system, the first aggregated information with second aggregated information from second clusters, to produce third aggregated information, wherein a first cluster comprises the first system and the second systems;
updating, by the first system, the first local model based on the third aggregated information, to produce an updated first local model; and
sensing, by the first system, second locally-occurring data based on the updated first local model.

12. The method of claim 11, wherein the aggregating of the first information with the second information satisfies a minimized reconstruction error of aggregated sensed data criterion.

13. The method of claim 11, wherein the first sensing matrix satisfies the data redundancy criterion with respect to the second sensing matrices.

14. The method of claim 11, wherein the first information about the first sensing matrix comprises a statistical parameter of the first locally-occurring data, or an extracted feature of the first locally-occurring data.

15. A non-transitory computer-readable medium comprising instructions that, in response to execution, cause a first system comprising at least one processor to perform operations, comprising:
training a first model based on first data, wherein, as a result of the training, the first model learns a first sensing matrix that samples the first data to satisfy a sparseness criterion;
aggregating first information about the first sensing matrix with second information about second sensing matrices of second systems, to produce first aggregated information;
aggregating the first aggregated information with second aggregated information from second clusters, wherein a first cluster comprises the first system and the second systems, to produce third aggregated information;
updating the first model based on the third aggregated information to create an updated first model; and
sensing second data based on the updated first model.

16. The non-transitory computer-readable medium of claim 15, wherein a local objective of training the first model comprises generating a matrix that satisfies the sparseness criterion, and wherein a global objective of the aggregating of the first aggregated information with the second aggregated information comprises satisfying a reconstruction error minimization criterion.

17. The non-transitory computer-readable medium of claim 15, wherein the operations further comprise:
selecting the second systems for the first cluster based on a knowledge graph, wherein the knowledge graph identifies respective relationships between the first system and respective second systems of the second systems based on data similarities or data correlations.

18. The non-transitory computer-readable medium of claim 17, wherein the operations further comprise:
based on the knowledge graph, generating, with a large language model, policy guidelines for data sensing, processing, and communication, wherein the policy guidelines are used to perform the learning of the first sensing matrix.

19. The non-transitory computer-readable medium of claim 17, wherein the operations further comprise:
based on the knowledge graph, generating, with a large language model, constraints applicable to designing sparsifying matrices and reconstruction functions, wherein the constraints are used to perform the learning of the first sensing matrix.

20. The non-transitory computer-readable medium of claim 17, wherein the operations further comprise:
generating a policy guidance and a recommendation with a large language model, wherein the aggregating of the first aggregated information with the second aggregated information is performed based on the policy guidance and the recommendation.
